(19) United States
(12) Patent Application Publication
(10) Pub. No.: US 2017/0078851 A1
(43) Pub. Date: Mar. 16, 2017

(54) ASSOCIATING A SIGNAL OBSERVATION WITH A LOCATION TAG

(71) Applicant: QUALCOMM Incorporated, San Diego, CA (US)

(72) Inventors: Meghna Agrawal, Sunnyvale, CA (US); Sai Pradeep Venkatraman, Santa Clara, CA (US); Ashok Bhatia, San Diego, CA (US); Gengsheng Zhang, Cupertino, CA (US)

(21) Appl. No.: 14/851,456

(22) Filed: Sep. 11, 2015

(51) Int. Cl. H04W 4/04; H04W 64/00

(52) U.S. Cl. CPC H04W 4/04; H04W 64/00

(57) ABSTRACT

Example methods, apparatuses, or articles of manufacture are disclosed herein that may be utilized, in whole or in part, to facilitate or otherwise support one or more operations or techniques for use in associating (tagging) a signal observation with a location tag, such as, for example, with a mobile communication device.

### BACKGROUND

1. Field

The present disclosure relates generally to position estimations of mobile communication devices and, more particularly, to associating (“tagging”) a signal observation with a location tag for use in or with mobile communication devices.

2. Information

Mobile communication devices, such as, for example, cellular telephones, portable navigation units, laptop computers, personal digital assistants, or the like are becoming more common every day. Certain mobile communication devices, such as, for example, location-aware cellular telephones, smart telephones, or the like may assist users in estimating their geographic locations by providing positioning assistance data obtained or gathered from various systems. For example, in some instances, certain mobile communication devices may obtain an estimate of their geographic location or so-called “position fix” by acquiring wireless signals from a satellite positioning system (SPS), such as the global positioning system (GPS) or other like Global Navigation Satellite Systems (GNSS), cellular base station, etc. via a cellular telephone or other wireless communications network. Acquired wireless signals may, for example, be processed by or at a mobile communication device, and its location may be estimated using known techniques, such as Advanced Forward Link Trilateration (AFLT), Observed Time Difference of Arrival (OTDOA), base station identification, or the like.

In an indoor environment, mobile communication devices may be unable to reliably receive or acquire satellite or like wireless signals to facilitate or support one or more position estimation techniques. For example, signals from an SPS or other wireless transmitters may be attenuated or otherwise affected in some manner (e.g., insufficient, weak, fragmentary, etc.), which may at least partially preclude their use for position estimations. At times, a mobile communication device may obtain a position fix by measuring ranges to three or more terrestrial wireless transmitter devices, such as access points, for example, positioned at known locations. Ranges may be measured, for example, by obtaining a Media Access Control identifier (MAC ID) address from wireless signals received from suitable access points and measuring one or more characteristics of received signals, such as signal strength, round trip delay, or the like. In some instances, an indoor location of a mobile communication device may be estimated via radio heat map signature matching, for example, in which current characteristics of wireless signals, such as signal strength, round trip delay, or the like received from access points at the device are compared with expected or previously measured signal characteristics stored as heat map values in a database.

At times, an indoor location of a mobile communication device may be estimated in connection with data extracted from an electronic digital map constructed for an indoor environment and/or provided by an indoor navigation system. An electronic digital map may comprise, for example, indoor features, such as doors, hallways, entry ways, walls, etc., points of interest, such as bathrooms, pay phones, room names, stores, etc., wireless network-related infrastructure, such as wireless transmitters, etc. as well as their estimated locations, which may be in the form of latitude and longitude, or some other coordinates for representing these locations at a particular precision. An electronic digital map may be communicated, such as upon entry by a mobile communication device of an indoor area of interest, for example, or may be stored at a server, such as to be accessible by a mobile communication device through selection of a URL, for example.

In some instances, however, extracting data from an electronic digital map may significantly tax available resources, such as memory space, battery life, etc. of mobile communication devices, etc., may increase or introduce complexity, increase associated costs, or the like. In addition, for more accurate positioning, a robust or precise electronic digital map, such as with accurate latitude, longitude, or like coordinates for all or most indoor features, points of interest, wireless network-related infrastructure, etc., for example, may be needed or otherwise useful. Maintenance of robust or precise electronic digital maps, however, may be time-consuming and/or operationally-expensive. Also, at times, precise location estimates of a mobile communication device's location may be unnecessary for some indoor applications. For example, in some instances, such as for location-based advertising, knowing that a mobile communication device is located in a general portion of a particular indoor area, such as near a particular store, a portion of a store, etc. may be sufficient.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating an implementation of an example process that may be performed to facilitate or support techniques for tagging a signal observation with a location tag.

FIG. 3 is a schematic diagram illustrating an implementation of an example process that may be performed to facilitate or support techniques for tagging a signal observation with a location tag.

FIG. 4 is a flow diagram illustrating another implementation of an example process that may be performed to facilitate or support techniques for tagging a signal observation with a location tag.

FIG. 5 is a schematic diagram illustrating another implementation of an example process that may be performed to facilitate or support techniques for tagging a signal observation with a location tag.

FIG. 6 is a schematic diagram illustrating an implementation of an example computing environment associated with a mobile device.

FIG. 7 is a schematic diagram illustrating an implementation of an example computing environment associated with a server.

### SUMMARY

Example implementations relate to techniques for tagging a signal observation with a location tag. In one implementation, a method may comprise, at a mobile device, obtaining a location tag for use in tagging one or more signal observations obtained via a sensor within the mobile device or co-located with the mobile device while the mobile device is present at a predetermined location and in response to an event; in response to a determination that the event has occurred, obtaining the one or more signal observations; identifying the one or more signal observations as being associated with the location tag in a message; and providing the message to a server.

In another implementation, a method may comprise, at a mobile device, receiving one or more messages comprising a plurality of location tags and one or more expected signature values corresponding to particular ones of the plurality of the location tags; performing a scanning operation to obtain one or more signal observations of an environment local to the mobile device; and estimating a location of the mobile device based, at least in part, on a location tag corresponding to an expected signature value matching at least one aspect of the one or more signal observations.

In yet another implementation, an apparatus may comprise means for obtaining a location tag for use in tagging one or more signal observations obtained via a sensor within a mobile device or co-located with the mobile device while the mobile device is present at a predetermined location and in response to an event; means for obtaining the one or more signal observations in response to a determination that the event has occurred; means for identifying the one or more signal observations as being associated with the location tag in a message; and means for providing the message to a server.

In yet another implementation, an apparatus may comprise a wireless transceiver to communicate with an electronic communications network; and one or more processors coupled to a memory to obtain a location tag for use in tagging one or more signal observations obtained via a sensor within a mobile device or co-located with the mobile device while the mobile device is present at a predetermined location and in response to an event; in response to a determination that the event has occurred, obtain the one or more signal observations; identify the one or more signal observations as being associated with the location tag in a message; and provide the message to a server. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate or support one or more operations or techniques for tagging a signal observation with a location tag for use in or with mobile communication devices. As used herein, “mobile device,” “mobile communication device,” “crowdsourcing device,” “location-aware mobile device,” or like terms may be used interchangeably and may refer to any kind of special purpose computing platform or apparatus that may from time to time have a position that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, or the like. It should be appreciated, however, that these are merely examples of mobile devices that may be used, at least in part, to implement one or more operations or techniques for tagging a signal observation with a location tag, and that claimed subject matter is not limited in this regard. It should also be noted that the terms “position” and “location” may be used interchangeably herein.

As used herein, a “location tag” refers to a user-configurable metadata for customizing or “tagging” signal observations for a predetermined location in connection with a particular event with one or more aspects of such a location and/or event while at such a location. As will be seen, at times, such a metadata may be included in a suitable data structure or like representation (e.g., a radio heat map, etc.) and may comprise, for example, a name of a particular store (e.g., Macy's®, etc.), portion or section of a store (e.g., Women's Shoes Section at Macy's®, Macy's® Main Entrance, etc.), shopping mall (e.g., Washington Square Mall, etc.), floor of a store, shop location in a mall, etc., geographical identification information, such as latitude and longitude coordinates, street, city, state name, etc., geo-spatial positioning information, such as a GNSS position fix (e.g., current, last known, etc.), etc., wireless network-related information, such as a MAC address of a proximate access point, etc., signal signatures, such as indicative of received signal strength (RSSI), round-trip time (RTT), etc., tagging entity-related information, such as a store or mall owner, proprietor, operator, etc. creating a tag, or any other suitable data. Particular examples of a location tag will be described in greater detail below.

In this context, “predetermined location” refers to a physical location associated with a stored characteristic of a wireless signal, such as represented via any suitable value in a suitable data structure or like representation (e.g., a radio heat map, etc.). For example, a predetermined location may comprise any suitable previously measured or modeled location within an indoor or like area of interest. A location may, for example, be measured or modeled using one or more appropriate techniques, such as fingerprinting, ray tracing, or the like. These or like techniques are generally known and need not be described in greater detail. Thus, at times, a stored signal characteristic may comprise, for example, an expected signal signature value of a radio heat map, such as expected RSSI, RTT, etc. for use in one or more signal matching operations, as discussed below.

As will also be seen, an event may comprise, for example, tagging one or more signal observations with one or more aspects of a predetermined location. For example, a tagging entity, such as an owner or operator of a venue (e.g., store, shopping mall, etc.), advertiser, authenticated user, etc. may travel around the venue and may tag one or more signal observations at different locations within the venue with particular names, locations, or other suitable data, as discussed below, thus, creating or generating location tags for these locations. In at least one implementation, an event for obtaining a location tag may comprise, for example, an electronic payment or purchase, such as performed via a mobile device using an appropriate host mobile application and/or service, such as, for example, Apple® Pay, Android® Pay, or the like, as also discussed below.

As alluded to previously, in an indoor environment or like partially or substantially enclosed area (e.g., an urban canyon, etc.), certain mobile devices may be unable to reliably receive or acquire satellite or like wireless signals to facilitate or support one or more position estimation techniques. For example, signals from an SPS or other wireless transmitters may be attenuated or otherwise affected in some manner (e.g., insufficient, weak, fragmentary, blocked, etc.), which may at least partially preclude their use for position estimations. As such, in an indoor or like environment, different techniques may be employed to enable navigation or location services. For example, a mobile device may obtain an indoor position fix by utilizing positioning assistance data that may be selectively provided by an indoor navigation or like system. Such positioning assistance data may include, for example, information to facilitate measurements of ranges to wireless access points at known fixed locations. For example, provided radio “heatmap” or “fingerprint” data indicating expected characteristics of wireless signals or so-called signal “signatures” stored indicative of received signal strength, round-trip delay times, or the like associated with access points in a database may enable a mobile device to correlate signal measurements with specific locations in an indoor area. Thus, by finding a signal signature in a database that more closely matches characteristics exhibited by signals currently observed at a mobile device, a location associated with a matching signal signature may, for example, be used as an estimated location of the mobile device. Radio “heatmap” or “fingerprint” matching is generally known and need not be described here in greater detail.

In some instances, a location of a mobile device may, for example, be estimated, at least in part, using data obtained or extracted from a provided electronic digital map, such as in connection with performing a scan of an indoor or like area of interest, as was indicated. For example, while traveling within an indoor area, a mobile device may perform an active or passive scan of the area to obtain one or more signal observations with respect to one or more proximate or “visible” wireless transmitters, such as IEEE 802.11 std. Wi-Fi access points, as one possible example. It should be noted that claimed subject matter is not limited to access points or Wi-Fi-related standards. For example, any other suitable wireless transmitter or standard (e.g., Li-Fi, etc.) may be utilized herein, in whole or in part. A “scan” or “scanning operation,” as used herein, typically refers to a technique implemented to acquire signals transmitted by one or more wireless transmitters and/or detect particular parameters encoded in the acquired signals (e.g., signal-related measurements, unique identifiers, etc.). As a way of illustration, an active scan may, for example, be performed via transmitting one or more requests, such as in the form of one or more unicast packets, for example, and receiving one or more responses, and a passive scan may be performed by “listening” for wireless signals broadcasted by proximate wireless transmitters, for example. Active and/or passive scans are generally known and need not be described here in greater detail.

In this context, “signal observation” or “observation” refer to a measured attribute or characteristic of a wireless signal transmitted by a wireless transmitter and acquired by an observing receiver or other sensor within a mobile device or co-located with a mobile device. For example, an observation may include cellular identification numbers (Cell IDs), MAC addresses, or like identifiers of one or more wireless transmitters, transmission power levels, characteristics and/or measurements of wireless signals, such as received signal strength indicator (RSSI), round-trip delay time (e.g., RTT, etc.), time of arrival (TOA), angle of arrival (AOA), or the like. Thus, at times, a mobile device may communicate one or more observations, such as RSSI, RTT, etc. obtained via a suitable scan of an indoor or like area of interest, for example, to a suitable server. In turn, a server may determine latitude-longitude or like coordinates of observed wireless transmitters (e.g., Wi-Fi access points, etc.), such as by referencing an electronic digital map of a corresponding indoor area, for example, if appropriate or applicable. A server may subsequently provide determined coordinates to a mobile device, for example, which may convert the coordinates into specific locations, such as by using one or more appropriate geocoding and/or reverse geocoding techniques. A mobile device may use the converted locations to obtain its position fix within an area using one or more appropriate techniques (e.g., triangulation, etc.).

As was indicated, at times, to facilitate or support these or like processes or techniques, however, a relatively accurate and/or robust electronic digital map of an indoor or like area, such as having precise latitude-longitude or like coordinates of associated indoor features, points of interest, wireless network-related infrastructure, etc. may be needed or otherwise useful. Thus, in some instances, such as in the absence of such a map, positioning or navigation capabilities of certain mobile devices located indoors may be less useful or possibly faulty. In addition, as was also indicated, extracting data from an electronic digital map may present challenges, significantly tax available resources, introduce complexity, increase associated costs, or the like. Also, in some instances, extracting and/or processing map-related data may not be necessary or useful since precise localization may not be needed for some mobile applications. For example, for location-based advertising, knowing that a mobile device is located in a general portion of an indoor area, such as next to an entrance to a particular store, a particular portion of a store, etc. may be a sufficient, as will be seen. Accordingly, it may be desirable to develop one or more methods, systems, and/or apparatuses that may implement sufficient indoor positioning, such as to facilitate or support mobile applications, which may include applications for which precise localization may not be necessary or useful, for example, while improving power consumption of mobile devices, reducing complexity and/or associated costs typically associated with extracting map-related data, or the like.

Thus, as described in greater detail below, in an implementation, one or more observations of a wireless signal may, for example, be tagged with location-related or other suitable data and may be used, at least in part, for indoor or like positioning, mobile advertising, or the like. For example, a location tag for one or more predetermined locations within an indoor or like area of interest may be obtained and associated with one or more signal observations obtained at a sensor within the mobile device or co-located with a mobile device. In response to a determination that some event has occurred, one or more obtained observations may, for example, be identified as being associated with a particular location tag. Tagged signal observations may be provided to a suitable server, such as via an appropriate message, for example, and the server may combine the observations to generate or update a database of expected signature values corresponding to particular tagged locations. A database or a portion thereof may be subsequently provided to participating mobile devices as part of positioning assistance data that may be used, at least in part, for positioning, such as in connection with fingerprint matching, as one possible example. Depending on an implementation, tagged signal observations may, for example, be used, at least in part, by mobile applications, such as for location-based advertising or other suitable purposes.

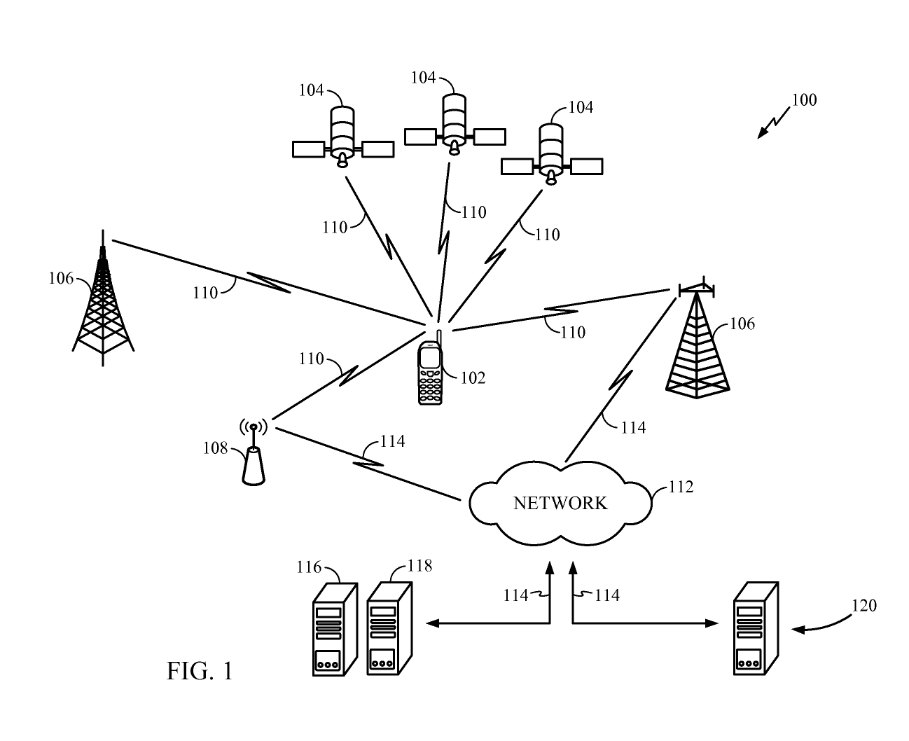

FIG. 1 is a schematic diagram illustrating features associated with an implementation of an example operating environment 100 capable of facilitating or supporting one or more processes or operations for tagging a signal observation with a location tag. It should be appreciated that operating environment 100 is described herein as a non-limiting example that may be implemented, in whole or in part, in the context of various electronic communications networks or combination of such networks, such as public networks (e.g., the Internet, the World Wide Web), private networks (e.g., intranets), wireless local area networks (WLAN, etc.), or the like. It should also be noted that claimed subject matter is not limited to outdoor implementations. For example, at times, one or more operations or techniques described herein may be performed, at least in part, in an indoor-like environment, which may include partially or substantially enclosed areas, such as urban canyons, town squares, amphitheaters, parking garages, rooftop gardens, patios, or the like. At times, one or more operations or techniques described herein may be performed, at least in part, in an indoor environment.

As illustrated, operating environment 100 may comprise, for example, one or more satellites 104, base station transceivers 106, transmitters 108, etc. capable of communicating with mobile device 102 via communication links 110 in accordance with one or more communication protocols. Satellites 104 may be associated with one or more satellite positioning systems (SPS), such as, for example, the United States Global Positioning System (GPS), the Russian GLONASS system, the European Galileo system, as well as any system that may utilize satellites from a combination of satellite systems, or any satellite system developed in the future. For example, satellites 104 may be from any one of several regional navigation satellite systems (RNSS) such as the Wide Area Augmentation System (WAAS), European Geostationary Navigation Overlay Service (EGNOS), Quasi-Zenith Satellite System (QZSS), etc. Base station transceivers 106, transmitters 108, etc. may be of the same or similar type, for example, or may represent different types of devices, such as access points, radio beacons, cellular base stations, base station transceivers, femtocells, WLAN access points, or the like, depending on an implementation.

Although not shown, in some instances, operating environment 100 may include, for example, a larger number of base station transceivers 106, transmitters 108, etc. It should be noted that one or more base station transceivers 106, transmitters 108, etc. may be capable of transmitting as well as receiving wireless signals. In a particular implementation, one or more transmitters 108 may be capable of communicating with mobile device 102 at a shorter range than at a range enabled by base station transceiver 106. For example, one or more transmitters 108 may be positioned in an indoor or like environment, as was indicated. One or more transmitters 108 may, for example, provide access to a wireless local area network (WLAN, e.g., IEEE std. 802.11 network, etc.) or wireless personal area network (WPAN, e.g., Bluetooth® network, etc.). In another example implementation, one or more transmitters 108 may comprise, for example, a femtocell transceiver capable of facilitating or supporting communication within operating environment 100 according to a cellular communication protocol.

In some instances, one or more base station transceivers 106, transmitters 108, etc. may, for example, be operatively coupled to an electronic communications network 112 that may comprise one or more wired or wireless communications or computing networks capable of providing suitable information, such as via one or more communication links 114, 110, etc. As will be seen, information may include, for example, wireless network-related data, such as locations, identities, transmission power levels, signal-related characteristics, observations, etc. of one or more base station transceivers 106, transmitters 108, etc., position fixes obtained via a GNSS, one or more messages with tagged signal observations, or any other suitable data, location-related or otherwise, capable of facilitating or supporting one or more operations or processes associated with operating environment 100.

In an implementation, network 112 may be capable of facilitating or supporting communications between suitable computing platforms or devices, such as, for example, mobile device 102, one or more base station transceivers 106, transmitters 108, as well as one or more servers associated with operating environment 100. In some instances, servers may include, for example, a location server 116, positioning assistance server 118, as well as one or more other servers, indicated generally at 120 (e.g., navigation, information, map, crowdsourcing, etc. server, etc.), capable of facilitating or supporting one or more operations or processes associated with operating environment 100. In a particular implementation, network 112 may comprise, for example, Internet Protocol (IP) infrastructure capable of facilitating a communication between mobile device 102 and servers 116, 118, or 120 via transmitter 108, base station transceiver 106 (e.g., via a network interface, etc.), or the like. In another implementation, network 112 may comprise cellular communication network infrastructure, such as, for example, a base station controller or master switching center (not shown) to facilitate mobile cellular communications with mobile device 102.

Location server 116 may provide an estimate of a location of mobile device 102 within operating environment 100. A location may, for example, be determined via a GNSS, input provided by an associated user, built-in or remote sensors, radio heat map, range-related measurements, location tags, or the like. At times, a location of mobile device 102 may be determined using a proximity to one or more reference points, such as by knowing which base station transceiver 106, transmitter 108, etc. mobile device 102 is using at a given time. Optionally or alternatively, a location of mobile device 102 may, for example, be determined, at least in part, on mobile device 102 using one or more applicable techniques (e.g., dead reckoning, etc.). In some instances, mobile device 102 may communicate Cell IDs, MAC addresses, etc. of one or more base station transceivers 106, transmitters 108, etc. to a suitable server, and may be provided an electronic digital map of an associated area or region. Mobile device 102 may also, for example, estimate its location based, at least in part, on provided map and locations or base station transceivers 106, transmitters 108, etc. using one or more appropriate techniques.

Positioning assistance server 118 may, for example, provide positioning assistance data, such as locations, identities, etc. of one or more base station transceivers 106, transmitters 108, or the like. For example, positioning assistance server 118 may provide locations of one or more base station transceivers 106, transmitters 108, etc. via a suitable reference frame, such as latitude-longitude, (X, Y, Z) coordinates in three-dimensional Cartesian coordinate space that may be mapped according to a global coordinate system, local coordinate system (e.g., a venue, etc.), etc., just to illustrate a few possible implementations. Positioning assistance server 118 may also provide signal observations comprising expected signature values for a particular location tag, for example.

Server 120 may comprise, for example, any other suitable server that may be used, at least in part, to facilitate or support one or more operations or processes discussed herein. For example, in some instances, server 120 may comprise a map server that may provide an electronic digital map as well as other positioning assistance data or like information for a particular area or region of interest. At times, an electronic digital map may comprise, for example, locations of one or more base station transceivers 106, transmitters 108, etc. relative to one or more areas or features (e.g., buildings, streets, etc.) within operating environment 100. Thus, an electronic digital map may, for example, be used, at least in part, to provide additional context to a user traveling within an area or region of interest within operating environment 100.

In particular implementations and as discussed herein, mobile device 102 may have circuitry and processing resources capable of measuring, collecting, storing, communicating, etc. suitable data, obtaining a location tag, tagging one or more observations with one or more aspects of a predetermined location, performing a scanning operation, estimating locations of one or more base station transceivers 106, transmitters 108, etc., computing a position fix, or the like. For example, mobile device 102 may compute a position fix based, at least in part, on pseudorange measurements to four or more SPS satellites 104. Here, mobile device 102 may compute such pseudorange measurements based, at least in part, on pseudonoise code phase detections in signals 110 acquired from four or more SPS satellites 104, for example. In particular implementations, mobile device 102 may receive from servers 116, 118, or 120 positioning assistance data to aid in the acquisition of signals transmitted by SPS satellites 104 including, for example, almanac, ephemeris data, Doppler search windows, just to name a few examples.

In other implementations, mobile device 102 may, for example, obtain a position fix by processing signals received from one or more terrestrial wireless transmitters positioned at known fixed locations (e.g., transmitter 108, base station transceiver 106, etc.) using any one of several techniques such as, for example, advanced forward trilateration (AFLT), observed time difference of arrival (OTDOA), or the like. In these particular techniques, a range from mobile device 102 may be measured to three or more of such transmitters based, at least in part, on pilot signals transmitted by the transmitters and received at mobile device 102. In some instances, locations or identities (e.g., a Cell ID, MAC address, etc.) of one or more base station transceivers 106, transmitters 108, etc. in a particular area associated with operating environment 100 may be provided by servers 116, 118, or 120 in the form of a base station almanac (BSA).

In at least one implementation, mobile device 102 may obtain a position fix by measuring or applying characteristics of acquired signals to a radio heatmap indicating expected RSSI, RTT, or like signatures at particular locations in an area or region of interest, such as in connection with tagged signal observations, for example. In particular implementations, a radio heatmap may associate identities of one or more transmitters 108 (e.g., a MAC address, which is discernible from a signal acquired from a local transmitter, etc.), expected RSSI from signals transmitted by the identified local transmitters, an expected RTT from the identified transmitters, means or standard deviations from these expected RSSI, RTT, etc. It should be understood, however, that these are merely examples to which claimed subject matter is not limited.

Even though a certain number of computing platforms or devices are illustrated herein, any number of suitable computing platforms or devices may be implemented to facilitate or otherwise support one or more techniques or processes associated with operating environment 100. For example, at times, network 112 may be coupled to one or more wired or wireless communications networks (e.g., Wi-Fi, etc.) so as to enhance a coverage area for communications with mobile device 102, one or more base station transceivers 106, transmitters 108, servers 116, 118, 120, or the like. In some instances, network 112 may facilitate or support femtocell-based operative regions of coverage, for example. Again, these are merely example implementations, and claimed subject matter is not limited in this regard.

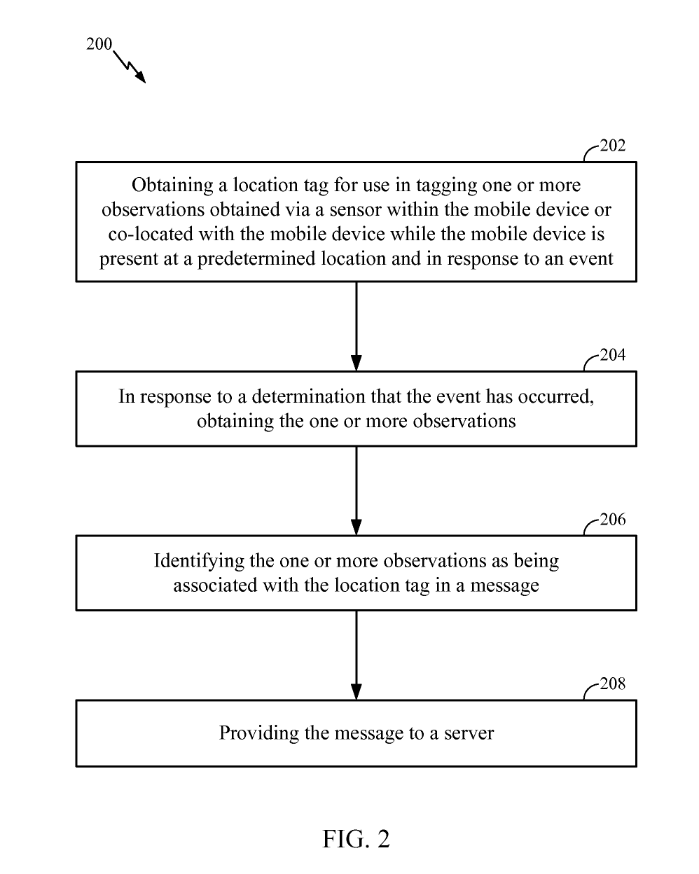

With this in mind, attention is now drawn to FIG. 2, which is a flow diagram illustrating an implementation of an example process 200 that may be performed, in whole or in part, to facilitate or support one or more operations or techniques for tagging a signal observation with a location tag. As was indicated, at times, process 200 may be implemented, at least in part, via a location-aware mobile device, such as, for example, mobile device 102 of FIG. 1, though claimed subject matter is not so limited. For example, in some instances, one or more operations of process 200 may be implemented, at least in part, via a server device, such as one or more servers 116, 118, and/or 120 of FIG. 1. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

Example process 200 may, for example, begin at operation 202 with obtaining a location tag for use in tagging one or more observations obtained via a sensor within the mobile device or co-located with the mobile device while the mobile device is present at a predetermined location and in response to an event. As was indicated, a location tag may be used, at least in part, to customize or “tag” signal observations for a predetermined location in connection with a particular event with a suitable metadata descriptive of one or more aspects of such a location and/or event. A location tag may be created or generated by a venue operator, advertiser, a user of a mobile device, etc. and may comprise, for example, a name of a particular store (e.g., Macy's®, etc.), portion or section of a store (e.g., Women's Shoes Section at Macy's®, Macy's® Main Entrance, etc.), shopping mall (e.g., Washington Square Mall, etc.), floor of a store, shop location in a mall, etc., geographical identification information, such as latitude and longitude coordinates, street, city, state name, etc., geo-spatial positioning information, such as a GNSS position fix (e.g., current, last known, etc.), etc., wireless network-related information, such as a MAC address of a proximate access point, etc., signal signatures, such as RSSI, RTT, etc., tagging entity-related information, such as a store or mall owner, proprietor, operator, etc. creating a tag, or any other suitable data. By way of example but not limitation, data that may be included into a location tag is illustrated in Table 1 below. It should be appreciated that claimed subject matter is not so limited. For example, depending on an implementation, a number of fields as well as data contained in the fields may vary.

TABLE 1
Example location tag

| Location Tag Data | Description |
|---|---|
| Scan measurement | Access point's MAC address along with |
| | RSSI, RTT, etc. measurement observed |
| | for this access point at a particular |
| | tagged location |
| Location-related data | Information about a particular tagged |
| | location (e.g., place name, etc.) |
| Last known nearest | Current or last known GNSS position fix |
| geo-location | along with age (e.g., how old is the |
| | position fix), Cell-ID, etc. |
| Tagging entity data | An entity that tagged a scan |
| | measurement |
| Encryption data/authentication | Encrypted code, password, etc., if |
| key/password | desired or applicable |
| Private/public | Whether a location tag is available to |
| | everyone or only to particular users |
| | (e.g., users of a particular store, |
| | application, etc.) |

A location tag may, for example, be obtained via any suitable communications, client-server-type or otherwise. For example, as discussed below, a mobile device may obtain a location tag by accessing an appropriate module storing one or more location tags for a particular indoor or like area of interest (e.g., a particular shopping mall, etc.), by accessing a remote server having one or more location tags for a particular indoor or like area of interest, or the like. As was indicated, a mobile device may, for example, obtain a particular location tag in response to a particular event, such as a selection at a user interface, just to illustrate one possible implementation. For example, a tagging entity, such as an owner or operator of a store, advertiser, authenticated user, etc. may travel or navigate around a store, mall, etc. and may create and/or provide tags for different predetermined locations of interest within the store, mall, etc., such as by tagging signal observations observed at these locations with location-related or other data, such as descriptive of one or more aspects of a predetermined location (e.g., as illustrated in Table 1, etc.). Here, a host application running on a mobile device may, for example, display a menu of possible candidate locations to be tagged, types of location tags (e.g., private, public, etc.), and/or various other input options (e.g., password, authentication questions or data, etc.) that a tagging entity may select (e.g., from a touchscreen, etc.) and/or input (e.g., from input fields, etc.). A host application, thus, may, for example, associate one or more observations (e.g., obtained via a sensor within the mobile device or co-located with the mobile device while the mobile device is present at a predetermined location, etc.) with one or more selected location tags. For example, in some instances, a host application may prompt a tagging entity to name a location tag (e.g., “North-West Entrance at Macy's®,” etc.), provide an authentication key, such as for purposes of authentication, or any other suitable input.

As was also indicated, in at least one implementation, an event for obtaining a location tag may comprise, for example, a payment or purchase performed via a mobile device using an appropriate host mobile application and/or service, such as Apple® Pay, Android® Pay, or the like. For example, a host application running on a mobile device (e.g., Apple® Pay, etc.) may allow an associated user to wirelessly communicate with a point of sale system (e.g., via a near field communication (NFC) protocol, etc.) so as to make a payment for goods and/or services. At times, such an NFC or like communication may, for example, be used, at least in part, to tag corresponding signal observations with location-related or other data relevant to this location. Here, a host application may also prompt a user to name a location, provide appropriate input, etc. or, optionally or alternatively, may tag the location without user input, such as in response to such a payment, for example. Thus, at times, a location tag may, for example, be obtained in response to a payment by a user of a mobile device at a checkout stand or like point of sale terminal (e.g., using Apple® Pay to make a purchase at a Starbucks® store at Washington Square Mall, etc.), which may associate the tag with a particular location (e.g., a Starbucks® store at Washington Square Mall, etc.). Claimed subject matter is not limited to particular tags or locations, of course.

With regard to operation 204, in response to a determination that the event has occurred, such as discussed above, one or more observations may, for example, be obtained. As was indicated, one or more observations may comprise, for example, a Cell ID, MAC address, RSSI, RTT, or like aspects. As was also indicated, one or more observations may, for example, be obtained through a scan (e.g., an active, passive, etc.) of an indoor or like area of interest so as to detect one or more proximate or “visible” wireless transmitters, such as Wi-Fi access points, for example, and decoding particular parameters or attributes encoded in acquired wireless signals using one or more appropriate techniques. Thus, one or more observations may, for example, be obtained via a sensor within a mobile device or co-located with a mobile device, such as while the mobile device is present at a predetermined location. As a way of illustration, in some instances, one or more observations may, for example, be obtained at a radio frequency (RF) receiver disposed on a mobile device, a Bluetooth® sensor disposed on a mobile device, a sensor disposed on a wearable device (e.g., smart watch, etc.) and in communication with a mobile device (e.g., via a short-range wireless communication link, etc.), or the like.

At operation 206, the one or more observations may, for example, be identified as being associated with the location tag in a message. For example, one or more obtained observations may be identified as corresponding to a particular predetermined location and that a location tag has been created or generated for this location. As such, a mobile device may associate the observation with the tag in a suitable message, such as for providing the message to a suitable server using one or more appropriate techniques. For example, for messaging, a location tag may be paired or combined with a signal observation in connection with any suitable communication protocol and/or process, such as via encoding, modulating, demodulating, decoding, etc. one or more properties of a wireless signal. These or like techniques are generally known and need not be described here in greater detail.

As indicated at operation 208, the message may, for example, be provided to a server. For example, depending on an implementation, a message having a location tag and an observation may be communicated to a suitable server or, optionally or alternatively, may be stored in a suitable local memory or a portion thereof, such as a buffer or cache of a mobile device, for example, for further processing, accessing, communicating, etc. A server may, for example, combine received or obtained tagged observations so as to generate or update a database of expected signature values corresponding to particular predetermined locations. A database or a portion thereof may, for example, be subsequently provided to participating mobile devices as part of positioning assistance data that may be used, at least in part, for positioning, such as in connection with fingerprint matching discussed above, as one possible example. Depending on an implementation, tagged signal observations may, for example, be used, at least in part, by mobile applications, such as for location-based advertising or other suitable purposes.

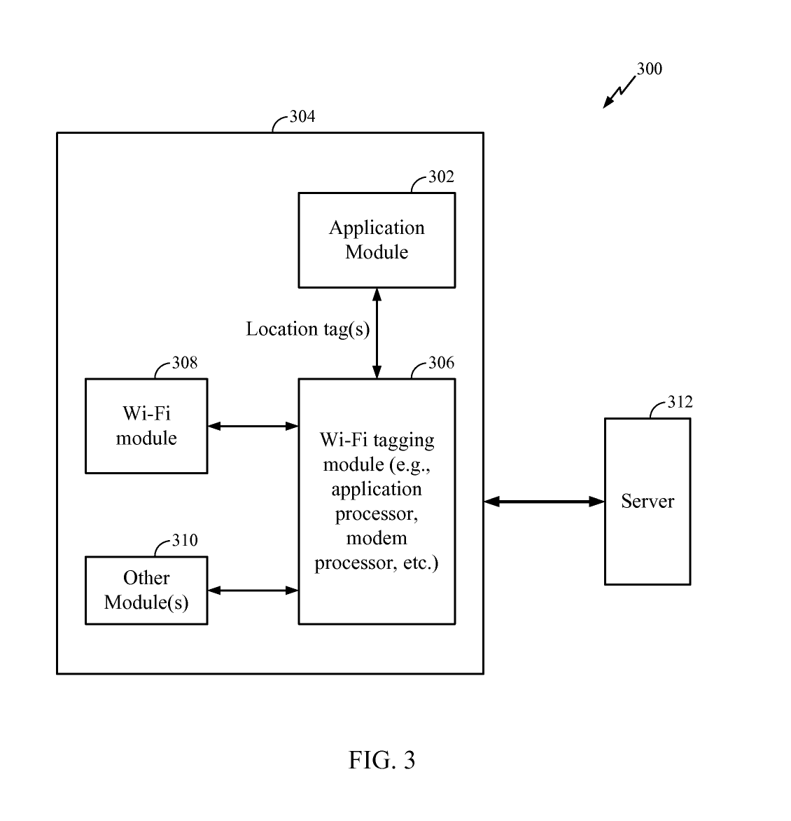

By way of example, as illustrated in a schematic diagram 300 of FIG. 3, an application module 302 of an associated mobile device 304 may obtain a location tag, such as in response to an event, as discussed above, and may provide the location tag to a Wi-Fi tagging module 306 comprising an application processor, modem processor or the like. It should be noted that mobile device 304 may correspond to or share common properties and/or components with mobile device 102 of FIG. 1, for example. As illustrated via a double-sided arrow, Wi-Fi tagging module 306 may, for example, communicate with a Wi-Fi module 308 so as to request and/or obtain one or more signal observations. In some instances, one or more signal observations may, for example, be obtained substantially contemporaneously with obtaining a location tag. As used herein, “substantially contemporaneously” or similar terms refer to a concept of a mutual temporal reference with respect to two or more signals obtained or acquired in substantially the same period of time. In some instances, a mutual temporal reference may comprise, for example, a signaling sequence in which an acquisition of two or more signals may differ in the amount of time attributable to electronic communication or other signal processing. By way of example but not limitation, substantially contemporaneous signals may, for example, be obtained or acquired within 50 milliseconds, a second, 5 seconds, etc. of each other. Claimed subject matter is not so limited, of course. Thus, depending on an implementation, an observation may, for example, be obtained at in a suitable sequence (e.g., 50 milliseconds, 5 seconds, 5 minutes, etc. apart), which may depend, at least in part, on a type of a scan (e.g., active or passive), network-related communication or packet schedule, locations of proximate wireless transmitters, processing modules or other components, implementation, or the like.

Thus, in some instances, Wi-Fi tagging module 306 may, for example, request Wi-Fi module 308 to implement a scan (e.g., active, passive, etc.) of an indoor area of interest, such as substantially contemporaneously with obtaining a location tag, as one possible example, and may associate one or more obtained observations with the tag. In at least one implementation, on receiving a location tag, Wi-Fi tagging module 306 may, for example, obtain any previous and/or sufficiently recent observations (e.g., locally stored signal observations, etc.) to be combined with the tag in a message. As also illustrated, Wi-Fi tagging module 306 may, for example, communicate with one or more other modules, referenced generally at 310, to obtain any other suitable data to facilitate or support one or more operations or processes for tagging a signal observation with a location tag. For example, data may include MAC addresses, Cell-ID, etc. of one or more wireless transmitters, last known GNSS position fix, or the like, as was indicated. In some instances, such as if Bluetooth® technology is utilized (e.g., one or more observations have been obtained via a Bluetooth® sensor, short-range communication link, etc.), for example, Wi-Fi tagging module 306 may communicate with one or more other modules 310 to obtain Bluetooth® IDs of applicable wireless transmitters or any other suitable data. As was indicated, Wi-Fi tagging module 306 may further associate one or more substantially contemporaneous observations and a location tag in a suitable message that may, for example, be provided to a server 312. Again, even though the above discussion references Wi-Fi and Bluetooth® technology, any other suitable technology may be unitized herein, in whole or in part.

In an implementation, a suitable server (e.g., server 312, etc.) may maintain received or obtained tagged signal observations in some manner. For example, a server may combine tagged signal observations to generate or update a database of expected signature values for particular tagged locations and may use the values for future positioning operations in corresponding indoor areas. A server may, for example, provide or furnish a database or a portion thereof to participating mobile devices as positioning assistance data for use in fingerprint matching, just to illustrate one possible implementation. For example, as discussed below, if a subsequent observation(s) matches one or more expected signatures in a scan, a mobile device may be inferred to be located at or near a location corresponding to a location tag. In another implementation, a mobile device may combine these observations to perform reverse access point positioning operations, such as for generating or updating estimated locations of access points, for example, to be provided as positioning assistance data. In some instances, a server may remove tagged signal observations from a database, such as if an associated location tag is relatively old (e.g., six month, one year, etc.), may geo-code applicable data (e.g., a corresponding place name, etc.) with geo-coordinates using one or more appropriate techniques, may verify that a location tag is unique to a particular indoor area and/or access point, cross-check duplicative location tags, or the like. Optionally or alternatively, tagged signal observations may, for example, be maintained at or by a mobile device, such as in a local memory in a similar fashion. For example, a mobile device may prioritize location tags that are more important (e.g., more frequently used, etc.) to a user, delete tags that are less frequently used, or the like.

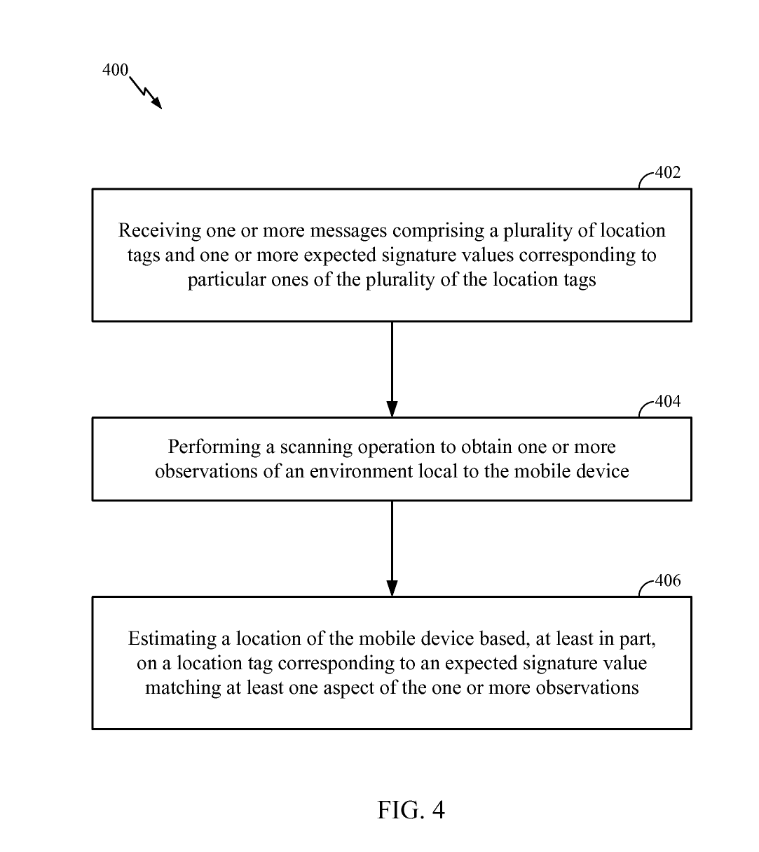

Attention is now drawn to FIG. 4, which is a flow diagram illustrating an implementation of another example process, referenced at 400, that may be performed, in whole or in part, to facilitate or support one or more operations or techniques for tagging a signal observation with a location tag. Likewise, process 400 may be implemented, at least in part, via a location-aware mobile device, such as, for example, mobile device 102 of FIG. 1, mobile device 304 of FIG. 3, etc., via a server device, such as one or more servers 116, 118, and/or 120 of FIG. 1, or any combination thereof. It should be noted that information acquired or produced, such as, for example, input signals, output signals, operations, results, etc. associated with example process 400 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

Example process 400 may, for example, begin at operation 402 with receiving, at a mobile device, one or more messages comprising a plurality of location tags and one or more expected signature values corresponding to particular ones of the plurality of the location tags. Depending on an implementation, a server may, for example, communicate one or more messages to participating mobile devices upon request (e.g., by a user, host application, etc.), upon entry of an indoor area of interest (e.g., a particular store, etc.), or the like. Optionally or alternatively, one or more messages may be received by a mobile device, such as by accessing a server through selection of an appropriate URL, for example. At times, a plurality of location tags may, for example, correspond to a number of particular predetermined locations tagged with respective signal observations within an indoor area of interest, such as a particular store, shopping mall, any portion thereof, or the like. As was indicated, one or more expected signature values may comprise, for example, RSSI, RTT, or like values that may or may not be obtained substantially contemporaneously with a particular location tag, such as in response to an event. In some instances, a plurality of received location tags may, for example, be maintained in a local cache or like memory of a mobile device and may be used, at least in part, for localization, advertising, etc., such as discussed below.

With regard to operation 404, a scanning operation to obtain one or more observations of an environment local to the mobile device may, for example, be performed. An environment local to a mobile device may comprise, for example, an indoor or like area of interest in which a mobile device is located (or proximate to), such as a shopping mall, store, particular portion thereof, or the like having one or more “visible” or proximate wireless transmitters. Here, a mobile device may, for example, perform an active scan or a passive scan of a local environment so as to acquire signals transmitted by one or more proximate wireless transmitters and/or detect particular aspects encoded in the acquired signals (e.g., signal-related measurements, unique identifiers, etc.), as discussed above.

At operation 406, a location of the mobile device may, for example, be estimated based, at least in part, on a location tag corresponding to an expected signature value matching at least one aspect of the one or more observations. For example, a mobile device may compare currently observed (e.g., via a scan) signal signature values with expected signal signature values of tagged signal observations stored in a local cache, such as via fingerprint matching discussed above, as one possible example. If a match of at least one aspect (e.g., RSSI, RTT, MAC address, Cell-ID, etc.) is found, a location associated with a corresponding location tag (e.g., Women's Shoes Section at Macy's®, Macy's® Main Entrance, etc.) may, for example, be used as an estimated location of the mobile device. At times, by comparing an observation (e.g., measured RSSI or RTT, etc.) with an expected signature value of tagged signal observations to determine a match, a mobile device may also compute or estimate an approximate distance from a location associated with a matching location tag (e.g., 10.0 meters from a current location of a mobile device to Macy's® Main Entrance, etc.) using one or more appropriate techniques. A mobile device may, for example, subsequently provide an estimated location, matched location tag, estimated distance from a location of the matched tag relative to an estimated location of the mobile device, or other suitable data to a server and/or an appropriate mobile application. For example, an appropriate application layer of a mobile device (e.g., an application programming interface, etc.) may utilize provided data, at least in part, for location-based advertisements or other purposes. Thus, at times, an appropriate application layer may, for example, provide an advertisement (e.g., a Starbucks® coupon, etc.) to a user of a mobile device based, at least in part, on an estimated location (e.g., a Starbucks® store, etc.).

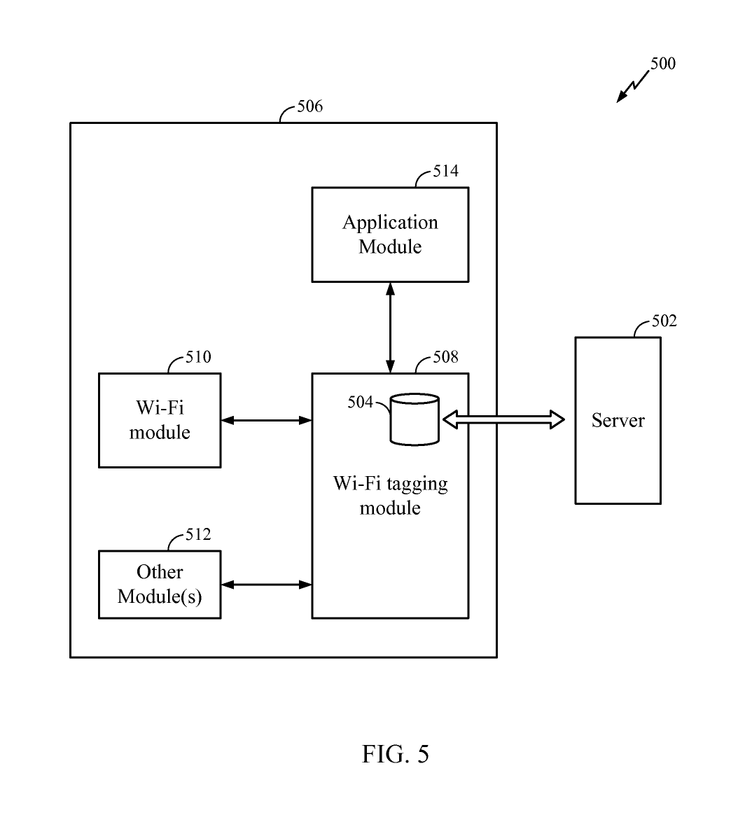

For example, as illustrated in a schematic diagram 500 of FIG. 5, a server 502 may communicate or make available applicable tagged signal observations comprising a plurality of location tags having corresponding expected signature values, such as discussed above. Tagged signal observations may, for example, be stored in a local cache 504 of a mobile device 506. It should be noted that mobile device 506 may correspond to or share common properties and/or components with mobile device 102 of FIG. 1, mobile device 304 of FIG. 3, etc., for example. As seen, in at least one implementation, local cache 504 may be included in a Wi-Fi tagging module 508, though claimed subject matter is not so limited. Thus, while mobile device 506 co-located with a user is traveling within an indoor or like area of interest, Wi-Fi tagging module 504 may communicate with a Wi-Fi module 510 so as to obtain one or more observations of an environment local to mobile device 506. For example, Wi-Fi tagging module 504 may request Wi-Fi module 510 to implement a scan (e.g., active, passive, etc.) of a surrounding indoor area of interest, such as to measure current RSSI, RTT, or like values of wireless signals from one or more proximate Wi-Fi access points.

As also illustrated, Wi-Fi tagging module 504 may communicate with one or more other modules, referenced generally at 512, to obtain any other suitable data, such as MAC addresses, Cell-IDs, Bluetooth® IDs, etc. of one or more proximate wireless transmitters, last known GNSS position fix, or the like. Having obtained appropriate data, Wi-Fi tagging module 508 may perform one or more matching operations, such as by comparing currently observed (e.g., via a scan) signal signature values with expected signal signature values of tagged signal observations stored in local cache 504, as was indicated. Having found a match, Wi-Fi tagging module 508 may, for example, estimate a location of mobile device 506, such as via a tagged location of a corresponding location tag, and may provide the tag (e.g., along with estimated distance from a tagged location and the estimated location, if applicable) to an application module 514, which may use the tag for advertisements or other purposes. For example, application module 514 may display an advertisement with a discount coupon for certain merchandise (or other promotional offer) on a screen or display of mobile device 506 while an associated user is passing by or otherwise near an applicable section or portion of a store. Location-based advertising, such as using push or pull technology, for example, to provide mobile device users with location based offers or incentives is generally known and need not be described here in greater detail.

Thus, in operative use, a store proprietor, owner, operator, authenticated user, marketer, etc. may employ a mobile device to tag locations of interest within the store or other indoor area, such as, for example, by selecting a number of candidate locations from a drop-down menu, inputting place names or other data, defining a level of privacy (e.g., private or public tags, etc.), making mobile payment, etc., as discussed above. As was also indicated, a mobile device may also associate one or more signal observations (e.g., MAC addresses, RSSI or RTT measurements, etc.) with a location tag obtained for a particular location and may provide the data to a suitable server. As such, a store proprietor, owner, operator, etc. may be capable of tagging appropriate predetermined locations without a hassle of determining and/or inputting latitude-longitude or like geo-coordinates for each location, for example. A store proprietor, owner, operator, etc. may also be capable of reaching specific target audiences, promote specific goods or services, direct foot traffic to a specific portion of a store, or the like. For example, a user traveling within a store may receive a notification on an associated mobile device with respect to some promotion or deal (e.g., a shoe sale, etc.) while the user is within a certain distance (e.g., five meters, etc.) from a tagged location (e.g., a shoe section, etc.). In addition, since it may not be needed or otherwise useful to extract location-related data from an electronic digital map constructed for an indoor environment, such as to estimate a location of a mobile device, for example, as was also discussed, power consumption of battery-operated mobile devices may be improved, processing resources may be increased, etc., which may improve overall user experience.

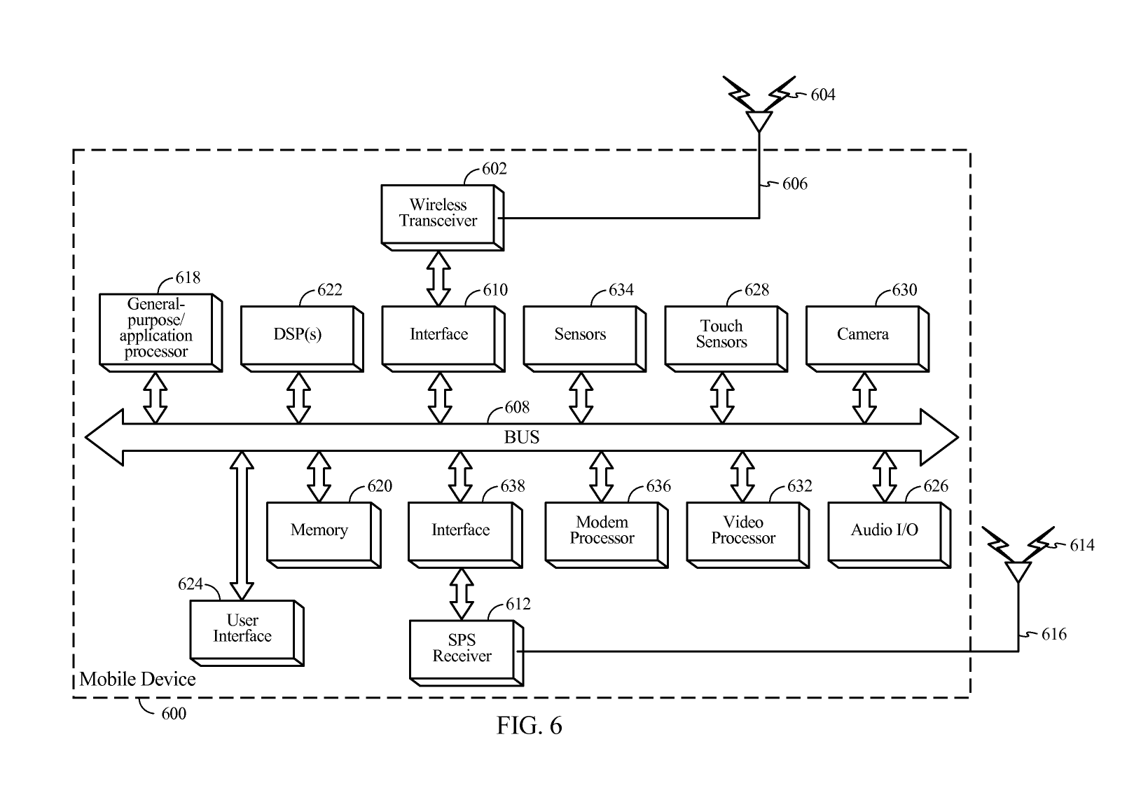

FIG. 6 is a schematic diagram of an implementation of an example computing environment associated with a mobile device that may be used, at least in part, to facilitate or support one or more operations or processes for tagging a signal observation with a location tag. An example computing environment may comprise, for example, a mobile device 600 that may include one or more features or aspects of mobile device 102 of FIG. 1, mobile device 304 of FIG. 3, mobile device 506 of FIG. 5, though claimed subject matter is not so limited. For example, in some instances, mobile device 600 may comprise a wireless transceiver 602 capable of transmitting or receiving wireless signals, referenced generally at 604, such as via an antenna 606 over a suitable wireless communications network. Wireless transceiver 602 may, for example, be capable of sending or receiving one or more suitable communications, such as one or more communications discussed with reference to FIGS. 1-5. Wireless transceiver 602 may, for example, be coupled or connected to a bus 608 via a wireless transceiver bus interface 610. Depending on an implementation, at times, wireless transceiver bus interface 610 may, for example, be at least partially integrated with wireless transceiver 602. Some implementations may include multiple wireless transceivers 602 or antennas 606 so as to enable transmitting or receiving signals according to a corresponding multiple wireless communication standards such as Wireless Local Area Network (WLAN) or Wi-Fi, Code Division Multiple Access (CDMA), Wideband-CDMA (W-CDMA), Long Term Evolution (LTE), Bluetooth®, just to name a few examples.

In an implementation, mobile device 600 may, for example, comprise an SPS or like receiver 612 capable of receiving or acquiring one or more SPS or other suitable wireless signals 614, such as via an SPS or like antenna 616. SPS receiver 612 may process, in whole or in part, one or more acquired SPS signals 614 for determining a location of mobile device 600. In some instances, one or more general-purpose application processors 618 (henceforth referred to as “processor”), memory 620, digital signal processor(s) (DSP) 622, or like specialized devices or processors not shown may be utilized to process acquired SPS signals 614, in whole or in part, calculate a location of mobile device 600, such as in conjunction with SPS receiver 612, or the like. Storage of SPS or other signals for implementing one or more positioning operations, such as in connection with one or more techniques for hybrid RTT and TOA/TDOA positioning, for example, may be performed, at least in part, in memory 620, suitable registers or buffers (not shown). Although not shown, it should be appreciated that in at least one implementation one or more processors 618, memory 620, DSPs 622, or like specialized devices or processors may comprise one or more processing modules capable of obtaining a location tag for use in tagging one or more signal observations obtained via a sensor within mobile device 600 or co-located with mobile device 600 while mobile device 600 is present at a predetermined location and in response to an event; in response to a determination that the event has occurred, obtaining the one or more signal observations; identifying the one or more signal observations as being associated with the location tag in a message; and providing the message to a server.

It should be noted that all or part of one or more processing modules may be implemented using or otherwise including hardware, firmware, software, or any combination thereof. Processing modules may be representative of one or more circuits capable of performing at least a portion of information computing technique or process. By way of example but not limitation, processor 618 or DSP 622 may include one or more processors, controllers, microprocessors, microcontrollers, application specific integrated circuits, digital signal processors, programmable logic devices, field programmable gate arrays, or the like, or any combination thereof. Thus, at times, processor 618 or DSP 622 or any combination thereof may comprise or be representative of means for obtaining a location tag for use in tagging one or more signal observations obtained via a sensor within mobile device 600 or co-located with mobile device 600 while mobile device 600 is present at a predetermined location and in response to an event, such as to implement operation 202 of FIG. 2, at least in part. In addition, in at least one implementation, processor 618 or DSP 622 may be representative of or comprise, for example, means for obtaining the one or more signal observations in response to a determination that the event has occurred, such as to implement operation 204 of FIG. 2, at least in part. Also, at times, processor 618 or DSP 622 may comprise, for example, or be representative of means for identifying the one or more signal observations as being associated with the location tag in a message, as illustrated in or described with respect to operation 206 of FIG. 2, for example. In some instances, processor 618 or DSP 622 may also be representative of or comprise, for example, means for providing the message to a server, such as to implement operation 204 of FIG. 2, at least in part.

As illustrated, DSP 622 may be coupled or connected to processor 618 and memory 620 via bus 608. Although not shown, in some instances, bus 608 may comprise one or more bus interfaces that may be integrated with one or more applicable components of mobile device 600, such as DSP 622, processor 618, memory 620, or the like. In various embodiments, one or more operations or functions described herein may be performed in response to execution of one or more machine-readable instructions stored in memory 620, such as on a computer-readable storage medium, such as RAM, ROM, FLASH, disc drive, etc., just to name a few examples. Instructions may, for example, be executable via processor 618, one or more specialized processors not shown, DSP 622, or the like. Memory 620 may comprise a non-transitory processor-readable memory, computer-readable memory, etc. that may store software code (e.g., programming code, instructions, etc.) that may be executable by processor 618, DSP 622, or the like to perform operations or functions described herein.

Mobile device 600 may comprise a user interface 624, which may include any one of several devices such as, for example, a speaker, microphone, display device, vibration device, keyboard, touch screen, etc., just to name a few examples. In at least one implementation, user interface 624 may enable a user to interact with one or more applications hosted on mobile device 600. For example, one or more devices of user interface 624 may store analog or digital signals on memory 620 to be further processed by DSP 622, processor 618, etc. in response to input or action from a user. Similarly, one or more applications hosted on mobile device 600 may store analog or digital signals in memory 620 to present an output signal to a user. In some implementations, mobile device 600 may optionally include a dedicated audio input/output (I/O) device 626 comprising, for example, a dedicated speaker, microphone, digital to analog circuitry, analog to digital circuitry, amplifiers, gain control, or the like. It should be understood, however, that this is merely an example of how audio I/O device 626 may be implemented, and that claimed subject matter is not limited in this respect. As seen, mobile device 600 may comprise one or more touch sensors 628 responsive to touching or like pressure applied on a keyboard, touch screen, or the like.

In an implementation, mobile device 600 may comprise, for example, a camera 640, dedicated or otherwise, such as for capturing still or moving imagery, or the like. Camera 640 may comprise, for example, a camera sensor or like imaging device (e.g., charge coupled device, complementary metal oxide semiconductor (CMOS)-type imager, etc.), lens, analog to digital circuitry, frame buffers, etc., just to name a few examples. In some instances, additional processing, conditioning, encoding, or compression of signals representing one or more captured images may, for example, be performed, at least in part, at processor 618, DSP 622, or the like. Optionally or alternatively, a video processor 632, dedicated or otherwise, may perform conditioning, encoding, compression, or manipulation of signals representing one or more captured images. Additionally, video processor 632 may, for example, decode or decompress one or more stored images for presentation on a display (not shown) of mobile device 600.

Mobile device 600 may comprise one or more sensors 634 coupled or connected to bus 608, such as, for example, one or more inertial sensors, ambient environment sensors, or the like. Inertial sensors of sensors 644 may comprise, for example, one or more accelerometers (e.g., collectively responding to acceleration of mobile device 600 in one, two, or three dimensions, etc.), gyroscopes or magnetometers (e.g., to support one or more compass or like applications, etc.), etc., just to illustrate a few examples. Ambient environment sensors of mobile device 600 may comprise, for example, one or more barometric pressure sensors, temperature sensors, ambient light detectors, camera sensors, microphones, etc., just to name few examples. Sensors 634 may generate analog or digital signals that may be stored in memory 620 and may be processed by DSP 622, processor 618, etc., such as in support of one or more applications directed to positioning or navigation operations, wireless communications, radio heat map learning, video gaming or the like.

In a particular implementation, mobile device 600 may comprise, for example, a modem processor 636, dedicated or otherwise, capable of performing baseband processing of signals received or downconverted via wireless transceiver 602, SPS receiver 612, or the like. Similarly, modem processor 636 may perform baseband processing of signals to be upconverted for transmission via wireless transceiver 602, for example. In alternative implementations, instead of having a dedicated modem processor, baseband processing may be performed, at least in part, by processor 618, DSP 622, or the like. In addition, in some instances, an interface 638, although illustrated as a separate component, may be integrated, in whole or in part, with one or more applicable components of mobile device 600, such as bus 608 or SPS receiver 612, for example. Optionally or alternatively, SPS receiver 612 may be coupled or connected to bus 608 directly. It should be understood, however, that these are merely examples of components or structures that may perform baseband processing, and that claimed subject matter is not limited in this regard.

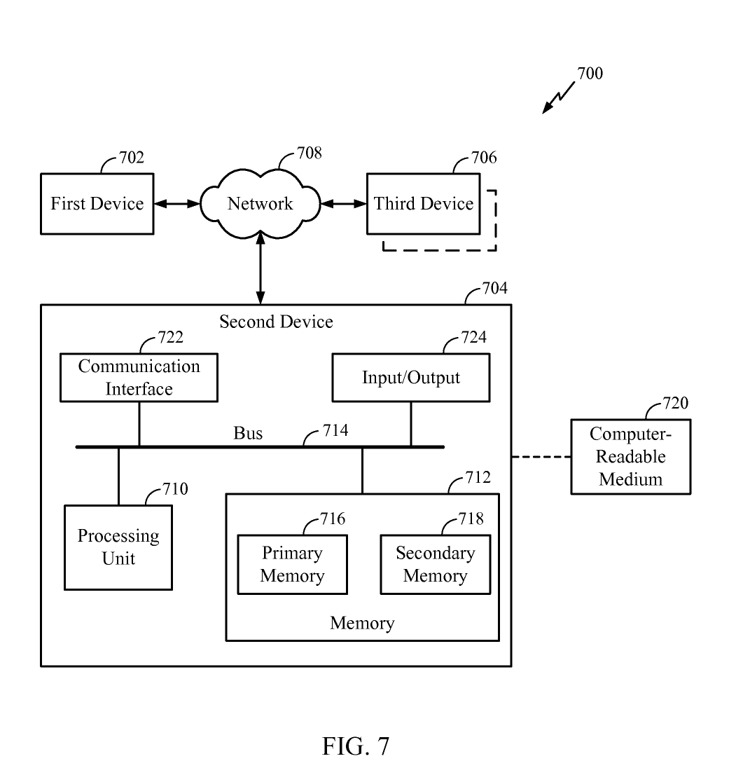

FIG. 7 is a schematic diagram illustrating an implementation of an example system or computing environment 700 that may be associated with or include one or more servers or other devices capable of partially or substantially implementing or supporting one or more operations or processes for tagging a signal observation with a location tag, such as discussed above in connection with FIGS. 1-5, for example. Computing environment 700 may include, for example, a first device 702, a second device 704, a third device 706, etc., which may be operatively coupled together via a communications network 708. In some instances, first device 702 may comprise a server capable of providing positioning assistance parameters, such as, for example, identities, locations, etc. of known wireless transmitters, radio heat map, base station almanac, electronic digital map, database of wireless transmitters, bias estimates, signal measurements, or the like. For example, first device 702 may also comprise a server capable of providing an electronic digital map to a mobile device based, at least in part, on a coarse or rough estimate of a location of the mobile device, upon request, or the like. First device 702 may also comprise a server capable of providing any other suitable positioning assistance parameters (e.g., an electronic digital map, radio heat map, etc.), relevant to a location of a mobile device. Second device 704 or third device 706 may comprise, for example, mobile devices, though claimed subject matter is not so limited. For example, in some instances, second device 704 may comprise a server functionally or structurally similar to first device 702, just to illustrate another possible implementation. In addition, communications network 708 may comprise, for example, one or more wireless transmitters, such as access points, femtocells, or the like. Of course, claimed subject matter is not limited in scope in these respects.

First device 702, second device 704, or third device 706 may be representative of any device, appliance, platform, or machine that may be capable of exchanging parameters and/or information over communications network 708. By way of example but not limitation, any of first device 702, second device 704, or third device 706 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 702, 704, and 706, respectively, may comprise one or more of a mobile device, wireless transmitter or receiver, server, etc. in accordance with example implementations described herein.

In an implementation, communications network 708 may be representative of one or more communication links, processes, or resources capable of supporting an exchange of information between at least two of first device 702, second device 704, or third device 706. By way of example but not limitation, communications network 708 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 706, there may be additional like devices operatively coupled to communications network 708. It is also recognized that all or part of various devices or networks shown in computing environment 700, or processes or methods, as described herein, may be implemented using or otherwise including hardware, firmware, software, or any combination thereof.

By way of example but not limitation, second device 704 may include at least one processing unit 710 that may be operatively coupled to a memory 712 via a bus 714. Processing unit 710 may be representative of one or more circuits capable of performing at least a portion of a suitable computing procedure or process. For example, processing unit 710 may include one or more processors, controllers, microprocessors, microcontrollers, application specific integrated circuits, digital signal processors, programmable logic devices, field programmable gate arrays, or the like, or any combination thereof. Although not shown, second device 704 may include a location-tracking unit that may initiate a position fix of a suitable mobile device, such as in an area of interest, for example, based, at least in part, on one or more received or acquired wireless signals, such as from an SPS, one or more Wi-Fi access points, etc. In some implementations, a location-tracking unit may be at least partially integrated with a suitable processing unit, such as processing unit 710, for example, though claimed subject matter is not so limited. In certain server-based or server-supported implementations, processing unit 710 may, for example, comprise means for receiving one or more messages comprising a plurality of location tags and one or more expected signature values corresponding to particular ones of the plurality of the location tags, such as to facilitate or support operation 402 of FIG. 4, at least in part. In some instances, processing unit 710 may, for example, comprise means for performing a scanning operation to obtain one or more signal observations of an environment local to a mobile device, such as to facilitate or support operation 404 of FIG. 4, at least in part. Depending on an implementation, processing unit 710 may also comprise, for example, means for estimating a location of the mobile device based, at least in part, on a location tag corresponding to an expected signature value matching at least one aspect of the one or more signal observations, such as to facilitate or support operation 406 of FIG. 4, at least in part.

Memory 712 may be representative of any information storage mechanism or appliance. Memory 712 may include, for example, a primary memory 716 and a secondary memory 718. Primary memory 716 may include, for example, a random access memory, read only memory, etc. While illustrated in this example as being separate from processing unit 710, it should be understood that all or part of primary memory 716 may be provided within or otherwise co-located/coupled with processing unit 710. Secondary memory 718 may include, for example, same or similar type of memory as primary memory or one or more information storage devices or systems, such as, for example, a disk drive, an optical disc drive, a tape drive, a solid state memory drive, etc. In certain implementations, secondary memory 718 may be operatively receptive of, or otherwise configurable to couple to, a computer-readable medium 720. Computer-readable medium 720 may include, for example, any non-transitory storage medium that may carry or make accessible information, code, or instructions for one or more of devices in computing environment 700. Computer-readable medium 720 may also be referred to as a machine-readable medium, storage medium, or the like.

Second device 704 may include, for example, a communication interface 722 that may provide for or otherwise support an operative coupling of second device 704 to at least communications network 708. By way of example but not limitation, communication interface 722 may include a network interface device or card, a modem, a router, a switch, a transceiver, and the like. Second device 704 may also include, for example, an input/output device 724. Input/output device 724 may be representative of one or more devices or features that may be configurable to accept or otherwise introduce human or machine inputs, or one or more devices or features that may be capable of delivering or otherwise providing for human or machine outputs. By way of example but not limitation, input/output device 724 may include an operatively configured display, speaker, keyboard, mouse, trackball, touch screen, information port, or the like.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units de-signed to perform the functions described herein, or combinations thereof.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, messages, parameters, frames, packets, content and/or the like. It should be understood, however, that all of these and/or similar terms are to be associated with appropriate physical quantities or manifestations, and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. Likewise, operation of a memory device to store bits, values, elements, symbols, characters, terms, numbers, numerals, measurements, messages, parameters, frames, packets, content and/or the like may comprise a physical transformation. With particular types of memory devices, such a physical transformation may comprise a physical transformation of an article to a different state or thing. For example, but without limitation, for some types of memory devices, a change in state may involve an accumulation and/or storage of charge or a re-lease of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) net-work, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method comprising, at a mobile device:
obtaining a location tag for use in tagging one or more signal observations obtained via a sensor within the mobile device or co-located with the mobile device while the mobile device is present at a predetermined location and in response to an event;
in response to a determination that the event has occurred, obtaining the one or more signal observations;
identifying the one or more signal observations as being associated with the location tag in a message; and
providing the message to a server.

2. The method of claim 1, wherein the providing the message to the server comprises: communicating the message to the server; storing the message in a local memory accessible by the server; or a combination thereof.

3. The method of claim 1, wherein the tagging is performed by: a venue operator; an advertiser; a user of the mobile device; or any combination thereof.

4. The method of claim 1, wherein the event comprises: a selection of the location tag at a user interface of the mobile device; an electronic purchase at the predetermined location using an application on the mobile device; or a combination thereof.

5. The method of claim 1, wherein the one or more signal observations comprise: a cellular identification number (Cell ID); a media access control (MAC) address; a transmission power level; a received signal strength indicator (RSSI) measurement; a round-trip time (RTT) measurement; a time of arrival (TOA) measurement; an angle of arrival (AOA) measurement; or any combination thereof.

6. The method of claim 1, wherein the location tag is stored as part of a radio heat map comprising an expected signal signature value for the predetermined location.

7. The method of claim 1, wherein the one or more signal observations are obtained through a scan of an area.

8. The method of claim 1, wherein the one or more signal observations are acquired from one or more wireless transmitters positioned at fixed locations within an area.

9. The method of claim 8, wherein the one or more wireless transmitters comprise: one or more WLAN access points; one or more base transceiver stations; one or more femtocells; one or more radio beacons; or any combination thereof.

10. The method of claim 1, wherein the sensor within the mobile device or co-located with the mobile device comprises: a radio frequency (RF) receiver; a Bluetooth® sensor; or a sensor disposed on a wearable device in communication with the mobile device.

11. The method of claim 1, wherein the location tag comprises: a scan measurement; location-related data; last known GNSS position fix; tagging entity data; geo-coordinates; authentication data; encryption data; a type of the location tag; or any combination thereof.

12. A method, at a mobile device, comprising:
receiving one or more messages comprising a plurality of location tags and one or more expected signature values corresponding to particular ones of the plurality of the location tags;
performing a scanning operation to obtain one or more signal observations of an environment local to the mobile device; and
estimating a location of the mobile device based, at least in part, on a location tag corresponding to an expected signature value matching at least one aspect of the one or more signal observations.

13. The method of claim 12, wherein the estimating the location of the mobile device further comprises estimating a distance between a current location of the mobile device and a location corresponding to the location tag having the expected signature value matching the at least one aspect of the one or more signal observations.

14. The method of claim 12, wherein the plurality of the location tags corresponds to a number of locations tagged by: a venue operator; an advertiser; a user of the mobile device; or any combination thereof.

15. The method of claim 12, wherein the one or more expected signature values corresponding to the particular ones of the plurality of the location tags comprise: expected received signal strength values at the location; expected round trip time values at the location; or a combination thereof.

16. The method of claim 12, wherein the environment local to the mobile device comprises an indoor environment.

17. The method of claim 12, wherein the location tag comprises: a scan measurement; location-related data; last known GNSS position fix; tagging entity data; geo-coordinates; authentication data; encryption data; a type of the location tag; or any combination thereof.

18. The method of claim 12, wherein the location tag corresponding to the expected signature value matching the at least one aspect of the one or more signal observations is stored as part of a radio heat map for the environment local to the mobile device.

19. The method of claim 12, wherein the expected signature value is matched to the at least one aspect of the one or more signal observations via fingerprint matching.

20. The method of claim 12, wherein the at least one aspect of the one or more signal observations comprises: received signal strength of a signal acquired from a wireless transmitter; a round-trip delay time corresponding to the signal acquired from the wireless transmitter; an identifier of the wireless transmitter; or any combination thereof.

21. The method of claim 12, and further comprising providing an advertisement to a user of the mobile device based, at least in part, on the estimated location of the mobile device.

22. An apparatus comprising:
means for obtaining a location tag for use in tagging one or more signal observations obtained via a sensor within a mobile device or co-located with the mobile device while the mobile device is present at a predetermined location and in response to an event;
means for obtaining the one or more signal observations in response to a determination that the event has occurred;
means for identifying the one or more signal observations as being associated with the location tag in a message; and
means for providing the message to a server.

23. The apparatus of claim 22, wherein the event comprises: a selection of the location tag at a user interface of the mobile device; an electronic purchase at the predetermined location using an application on the mobile device; or a combination thereof.

24. The apparatus of claim 22, wherein the location tag comprises: a scan measurement; location-related data; last known GNSS position fix; tagging entity data; geo-coordinates; authentication data; encryption data; a type of the location tag; or any combination thereof.

25. An apparatus comprising:
a wireless transceiver to communicate with an electronic communications network; and
one or more processors coupled to a memory to:
obtain a location tag for use in tagging one or more signal observations obtained via a sensor within a mobile device or co-located with the mobile device while the mobile device is present at a predetermined location and in response to an event;
in response to a determination that the event has occurred, obtain the one or more signal observations;
identify the one or more signal observations as being associated with the location tag in a message; and
provide the message to a server.

26. The apparatus of claim 25, wherein the tagging is performed by: a venue operator; an advertiser; a user of the mobile device; or any combination thereof.

27. The apparatus of claim 25, wherein the event comprises: a selection of the location tag at a user interface of the mobile device; an electronic purchase at the predetermined location using an application on the mobile device; or a combination thereof.

28. The apparatus of claim 25, wherein the location tag comprises at least one of the following: a scan measurement; location-related data; last known GNSS position fix; tagging entity data; geo-coordinates; authentication data; encryption data; a type of the location tag; or any combination thereof.

29. The apparatus of claim 25, wherein the one or more signal observations are obtained through a scan of an area.

30. The apparatus of claim 25, wherein the sensor within the mobile device or co-located with the mobile device comprises: a radio frequency (RF) receiver; a Bluetooth® sensor; or a sensor disposed on a wearable device in communication with the mobile device.
